(19) United States
(12) Patent Application Publication
(10) Pub. No.: US 2024/0283890 A1
(43) Pub. Date: Aug. 22, 2024

(54) DEVICE, METHOD AND PROGRAM FOR COMBINING VIDEO SIGNALS

(71) Applicant: NIPPON TELEGRAPH AND TELEPHONE CORPORATION, Tokyo (JP)

(72) Inventors: Toshihito FUJIWARA, Musashino-shi, Tokyo (JP); Tatsuya FUKUI, Musashino-shi, Tokyo (JP); Ryota SHIINA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/681,662

(22) PCT Filed: Aug. 11, 2021
(86) PCT No.: PCT/JP2021/029618

§ 371 Date: Feb. 6, 2024

(51) Int. Cl. H04N 5/66; H04N 5/12

(52) U.S. Cl. CPC H04N 5/66; H04N 5/12

(57) ABSTRACT

An object of the present disclosure is to reduce a delay in time from the video input of an asynchronous video to the output of a composite video.

The present disclosure is a device and a method, in which the device composes a plurality of video signals which have been input asynchronously into a video signal displayed on one screen, wherein the one screen is constituted by a plurality of sub-screens the number of which is greater than the plurality of video signals, and the plurality of video signals are arranged on a sub-screen out of the plurality of sub-screens such that an output delay of each video signal is reduced to compose the plurality of video signals.

### TECHNICAL FIELD

The present disclosure relates to a video composition device that composes screens into one from a plurality of video input signals and outputs the result.

### BACKGROUND ART

In recent years, many video devices have been used. A wide variety of numbers of pixels (resolutions), frame rates, and the like are used for videos of such a great number of video devices. Although there are differences in physical signals, control signals, and the like depending on the standard, the video signal of this video device has one screen transmitted using a time of 1 divided by the frame rate. For example, in the case of a video signal of 60 frames per second, the video for one screen is transmitted over 1/60 of a second, that is, approximately 16.8 milliseconds (hereinafter referred to as 60 fps (frame per second)).

As a method of using these videos, there is a form in which a plurality of cameras are displayed on monitors the number of which is smaller than the number of cameras, such as in a video conference. In this case, screen composition is performed, for example, by split-displaying a plurality of videos on one screen, or by fitting other video screens into a certain video screen through the reduction of the size thereof.

Since the timings of video signals are not synchronized and the timings of other video signals to be composed are different from each other, the signals are temporarily buffered in a memory or the like before composition thereof. As a result, a delay occurs in the output of a composite screen.

Assuming that an ensemble at a remote location or the like is performed in a video conference where such screen composition is performed, a delay associated with this composition will greatly impair its feasibility. For example, in the case of a song of 120 beats per second (hereinafter referred to as 120 BPM (beat per minute)), the duration of one beat is 60/120 seconds=500 milliseconds. Assuming that it is necessary to match this with an accuracy of 5%, it is necessary to suppress a delay from image capturing with a camera to displaying the result in 500×0.05=25 milliseconds or less.

The actual process of capturing an image with a camera and displaying the result needs to include not only the time required for composition processing but also other delays such as image processing time in the camera, display time on the monitor, and transmission time. As a result, in the related art, it is difficult to perform cooperative work in applications where timing is important, such as ensemble performance while viewing videos mutually at remote locations.

Consequently, for cooperative work that strictly requires a low delay, it is necessary to provide a system that composes a plurality of screens at multiple locations and the like and that reduces a delay in time from the video input of an asynchronous video to the output of a composite video.

### CITATION LIST

### Non Patent Literature

[NPL 1] VESA and Industry Standards and Guidelines for Computer Display Monitor Timing (DMT), Version 1.0, Rev. 13, Feb. 8, 2013

### SUMMARY OF INVENTION

### Technical Problem

An object of the present disclosure is to reduce a delay in time from the video input of an asynchronous video to the output of a composite video.

### Solution to Problem

According to the present disclosure, there are provided a device and a method, in which the device composes a plurality of video signals which have been input asynchronously into a video signal displayed on one screen, wherein the one screen is constituted by a plurality of sub-screens the number of which is greater than the plurality of video signals, and the plurality of video signals are arranged on a sub-screen out of the plurality of sub-screens such that an output delay of each video signal is reduced to compose the plurality of video signals.

The device of the present invention can also be realized by a computer and a program, and the program can be recorded on a recording medium and provided through a network. The program of the present disclosure is a program for realizing a computer as each functional unit provided in the device according to the present disclosure, and is a program for causing a computer to execute each step included in the method executed by the device according to the present disclosure.

### Advantageous Effects of Invention

According to the present disclosure, it is possible to reduce a delay in time from the video input of an asynchronous video to the output of a composite video.

### BRIEF DESCRIPTION OF DRAWINGS

FIG. 1 shows an example of information on a screen included in a video signal.

FIG. 2 shows a system configuration example of the present disclosure.

FIG. 3 shows an example of composing four input frames into one output frame.

FIG. 4 shows an example of sub-screens obtained by dividing one screen.

FIG. 5 shows an example of input frames and an output frame.

FIG. 6 shows an example of arrangement on sub-screens.

FIG. 7 shows an example of input frames and an output frame.

FIG. 8 shows an example of arrangement on sub-screens.

FIG. 9 shows a configuration example of a video composition device.

### DESCRIPTION OF EMBODIMENTS

Hereinafter, embodiments of the present disclosure will be described in detail with reference to the accompanying drawings. Meanwhile, the present disclosure is not limited to embodiments shown below. These examples are merely illustrative, and the present disclosure can be implemented in various modified and improved forms on the basis of the knowledge of those skilled in the art. Meanwhile, in the present specification and the drawings, components with the same reference numerals are assumed to indicate the same ones.

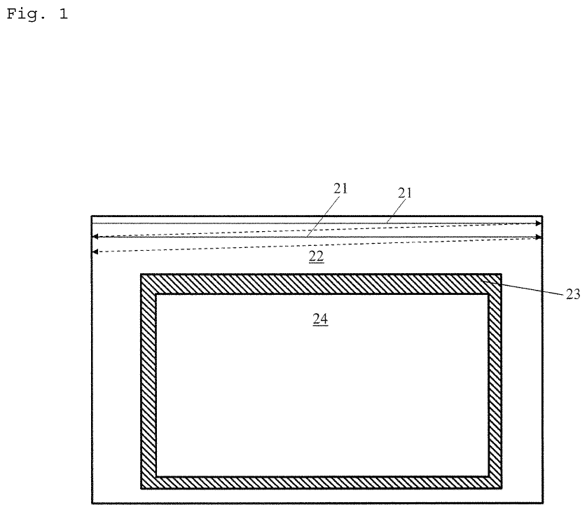

FIG. 1 shows an example of information on a screen included in a video signal. The information on the screen is transmitted by scanning the screen in a lateral direction for each scanning line 21 and scanning the scanning lines 21 below in sequence. This scanning includes a display screen 24 as well as overhead information/signals such as a blanking portion 22 and a border portion 23. The blanking portion 22 may include information other than video information, such as control information and audio information (see, for example, NPL 1).

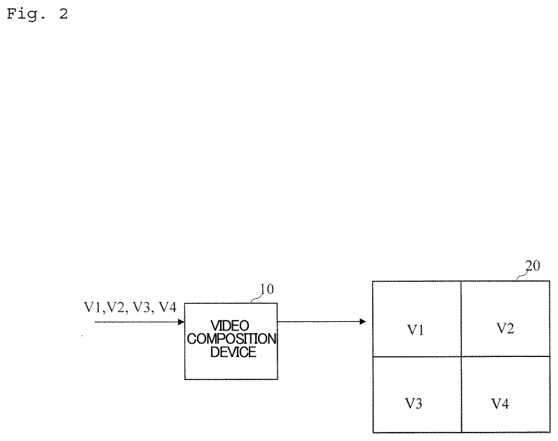

FIG. 2 shows a system configuration example of the present disclosure. In the present disclosure, as an example, four video signals V1 to V4 are input to a video composition device 10, and the video composition device 10 composes the four video signals into a video signal displayed on one screen 20 and outputs the composed signal. In video signals, one screen is transmitted using a time of 1 divided by the frame rate. For example, in the case of a video signal of 60 frames per second, the video signal for one screen is transmitted over 1/60 of a second, that is, approximately 16.7 milliseconds (hereinafter referred to as 60 fps (frame per second)).

Information on one screen at each point in time included in a video signal is referred to as a “frame,” information on one screen of each video signal input to the video composition device 10 is referred to as an “input frame,” and information on one composed screen output from the video composition device 10 is referred to as an “output frame.”

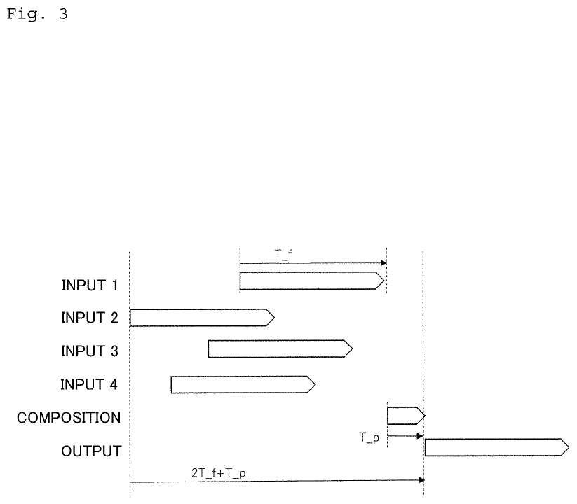

FIG. 3 shows an example in which four videos with different timings are used as an input and composed into one screen to be output. A case in which the video composition device 10 reads all input video screens, composes these screens, and outputs the result is considered. In this case, when the frame time is T_f and the composition processing time is T_p, the output frame will be delayed by a maximum of 2T_f+T_p from a point in time of input of the first input frame. For example, considering a video of 60 fps, there is a possibility that the composed video may include a delay of 2 frames' worth of time or more, that is, 33.3 milliseconds or more.

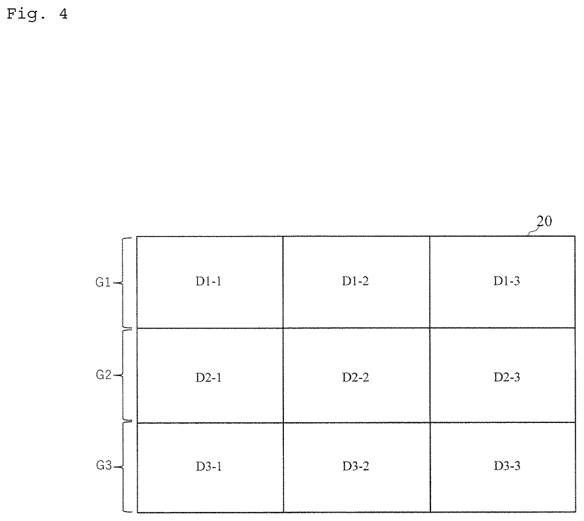

FIG. 4 shows an example of a screen 20 of the present embodiment. In the present embodiment, an example in which the screen 20 is divided into nine sub-screens of 3×3 is shown. In the present disclosure, one screen 20 shown in FIG. 2 is constituted by five or more sub-screens the number of which is greater than the plurality of video signals V1 to V4. The screens in a lateral direction arranged on the same scanning line among the divided screen are regarded as one group, and the group is referred to as a “sub-screen group.” For example, in a case where the video composition device 10 composes four video signals of inputs 1 to 4, sub-screens D1-1, D1-2, and D1-3 lined up in a lateral direction are defined as a sub-screen group G1, sub-screens D2-1, D2-2, and D2-3 lined up in a lateral direction are defined as a sub-screen group G2, and sub-screens D3-1, D3-2, and D3-3 lined up in a lateral direction are defined as a sub-screen group G2. That is, data of the output frame is output first from the sub-screen group G1 located at the top, followed by the sub-screen groups G2 and G3.

The present disclosure is a system that receives a plurality of asynchronous videos as an input to compose those images, and is characterized by arranging the screen 20 from the top to bottom so that an output delay is reduced in the order of the earliest input timing. In particular, it is characterized in that the number of output division screens is greater than the number of input frames, and that there may be a region in the screen 20 which is not used as an output of the input frame.

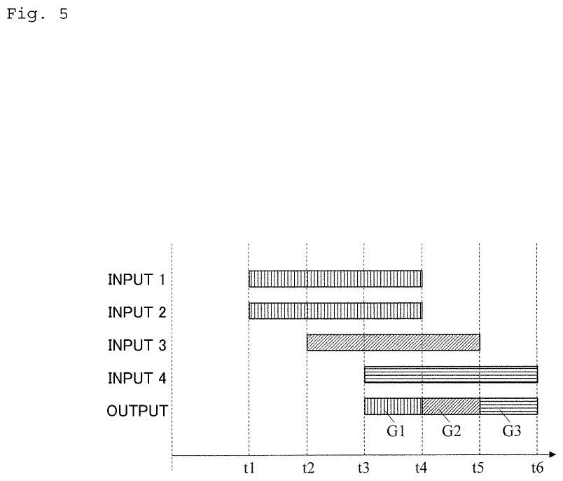

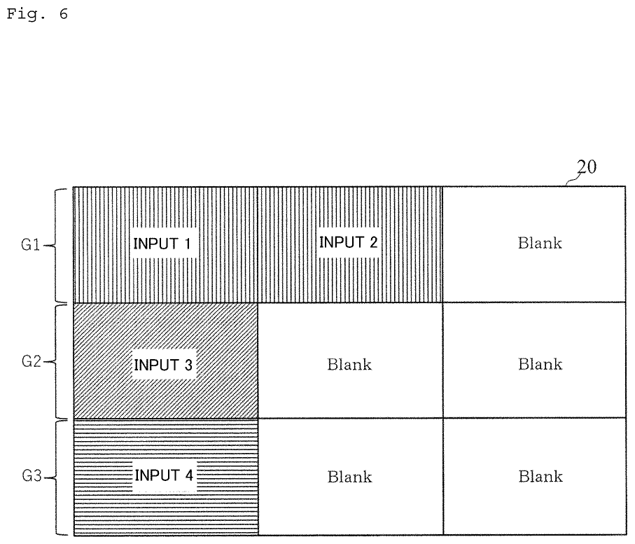

FIGS. 5 and 6 show examples of screen composition of the present disclosure. FIGS. 5 and 6 show the output timing of an output frame obtained by lining up four input frames in the order of the earliest input timing and composing these frames. In this example, there are the sub-screen groups G1 to G3 from top to bottom, and each sub-screen group can output up to three screens. Any number of sub-screen groups can be set, and any number (n>=1) of divided screens within a sub-screen group can be set. In addition, these numbers can be changed dynamically according to the number of input frames.

In FIGS. 5 and 6, the inputs 1 and 2 are output to the sub-screen group G1 because the data input can be completed by time t4 when the output of the sub-screen group G1 is completed. For example, as shown in FIG. 6, the inputs 1 and 2 can be arranged from the left of the sub-screen group screen G1. However, this arrangement is arbitrary within the same sub-screen group G1. In this example, the rightmost sub-screen D1-3 of the sub-screen group G1 is blank with nothing displayed.

The input 3 is output to the sub-screen group G2 because the data input can be completed by time t5 when the output of the sub-screen group G2 is completed. For example, as shown in FIG. 6, the above input can be arranged on the leftmost sub-screen D2-1 of the sub-screen group screen G2. However, this arrangement is arbitrary within the same sub-screen group G2. In this example, the central and rightmost sub-screens D2-2 and D2-3 of the sub-screen group G2 are blank.

The input 4 is output to the sub-screen group G3 because the data input can be completed by time t6 when the output of the sub-screen group G3 is completed. For example, as shown in FIG. 6, the above input can be arranged on the leftmost sub-screen D3-1 of the sub-screen group screen G3. However, this arrangement is arbitrary within the same sub-screen group G3. In this example, the central and rightmost sub-screens D3-2 and D3-3 of the sub-screen group G3 are blank.

With such a screen arrangement, it is possible to output each input frame as a composite screen with the shortest delay. As the number of sub-screen groups to be divided increases, it is possible to make adjustment at a finer granularity.

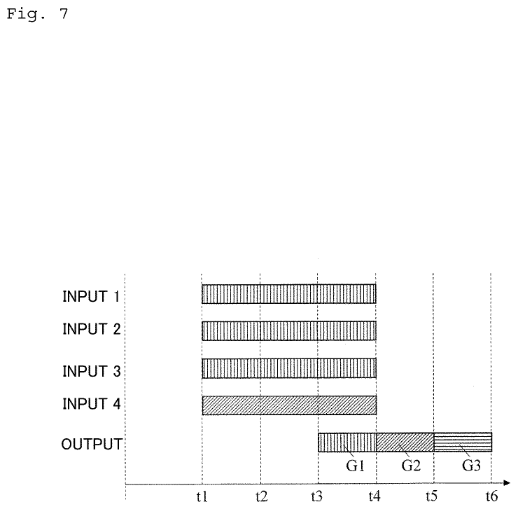

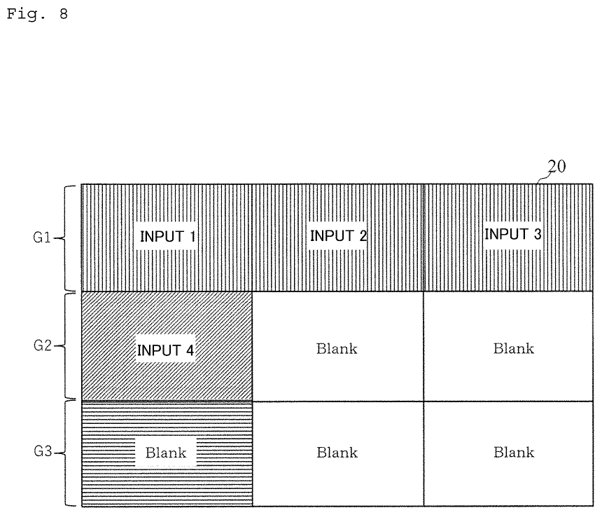

In a case where it is difficult to arrange screens in the sub-screen group with the shortest delay, the screens can also be arranged step by step in the sub-screen group with a shorter delay. For example, as shown in FIG. 7, in a case where all the frames of the inputs 1 to 4 match at the same input timing, only up to three screens can be arranged in the sub-screen group G1. In such a case, as shown in FIG. 8, one can be arranged in a nearby sub-screen group G2 and output. In the drawing, only the input 4 is arranged in the sub-screen group G2. This makes it possible to reduce an average delay.

In a case where the clocks of the input video and the output video are out of sync with each other, even at the same screen frame rate, the timing of each input frame and output frame gradually changes as the screen frame passes. In the method of the present disclosure, a video signal that meets the output timing of the sub-screen group is arranged on any of the sub-screens included in the sub-screen group, and the screen arrangement can be changed each time so as to minimize the delay even with such a change.

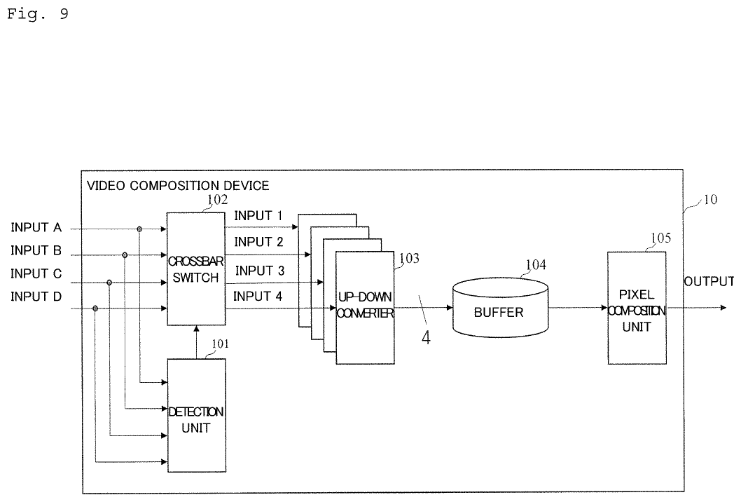

FIG. 9 shows a configuration example of the video composition device 10 according to the present embodiment. The video composition device 10 according to the present embodiment includes a detection unit 101, a crossbar switch 102, an up-down converter 103, a buffer 104, and a pixel composition unit 105. The drawing shows four inputs and one output, but any number of inputs and outputs can be used.

The element 101 is a functional unit that detects the input order within a frame time with respect to N inputs. The element 102 is a crossbar switch and has a function of rearranging and outputting the input order from 101 in the order of detection results.

The element 103 is an up-down converter that scales the number of pixels to an arbitrary size.

The elements 102 and 103 may be reversely connected to the inputs (a, b, c, d, . . . ). That is, the element 103 performs scaling on the inputs a, b, c, and d, and then the element 102 may rearrange and output them in the order of input.

The element 104 is a buffer. The inputs of the elements 103 or 102 can be buffered and output in any order.

The element 105 is a pixel composition unit. Pixel data is read out from the element 104 in the order of output in the entire output screen, composed and output. This timing is based on the above. The element 105 may add any control signal to the blanking portion of the screen.

The video composition device 10 of the present disclosure can also be realized by a computer and a program, and the program can be recorded on a recording medium and provided through a network.

### Effect of Present Disclosure

The system according to the present disclosure can shorten the delay time to output after composition with respect to an asynchronous video input signal. This makes it possible to perform cooperative work in a system that composes a plurality of screens at multiple locations and the like with strict low-delay requirements and especially stricter low-delay requirements for specific inputs.

### Point of Present Disclosure

In a system that composes and displays videos at multiple locations, it is necessary to reduce a delay in composition processing in cooperative work that strictly requires a low delay, such as an ensemble. The present disclosure is a system that inputs a plurality of asynchronous videos to compose those images, and arranges the screen 20 from the top to bottom so that an output delay is reduced in the order of the earliest input timing. Thereby, in the present disclosure, it is possible to perform cooperative work that strictly requires a low delay in a system that composes a plurality of screens at multiple locations and the like.

### INDUSTRIAL APPLICABILITY

The present disclosure can be applied to the information communication industry.

### REFERENCE SIGNS LIST

10: Video composition device
20: Screen
21: Scanning line
22: Blanking portion
23: Border portion
24: Display screen
101: Detection unit
102: Crossbar switch
103: Up-down converter
104: Buffer
105: Pixel composition unit

1. A device configured to compose a plurality of video signals which have been input asynchronously into a video signal displayed on one screen,
wherein the one screen is constituted by a plurality of sub-screens the number of which is greater than the plurality of video signals, and
the plurality of video signals are arranged on a sub-screen out of the plurality of sub-screens such that an output delay of each video signal is reduced to compose the plurality of video signals.

2. The device according to claim 1, wherein the plurality of video signals are arranged from the top of the plurality of sub-screens to the bottom thereof in order from the earliest input timing of the video signals.

3. The device according to claim 1, wherein a video signal included in the plurality of video signals is output for each sub-screen group constituting a portion of the one screen, and
a video signal that meets an output timing of the sub-screen group is arranged on any of the sub-screens included in the sub-screen group.

4. The device according to claim 3, wherein the sub-screen group is a set of sub-screens arranged on the same scanning line of the screen.

5. A method of composing a plurality of video signals which have been input asynchronously into a video signal displayed on one screen,
wherein the one screen is constituted by a plurality of sub-screens the number of which is greater than the plurality of video signals, and
the plurality of video signals are arranged on a sub-screen out of the plurality of sub-screens such that an output delay of each video signal is reduced to compose the plurality of video signals.

6. A non-transitory computer-readable medium having computer-executable instructions that, upon execution of the instructions by a processor of a computer, cause the computer to function as the device according to claim 1.
